(19) United States
(12) Patent Application Publication
(10) Pub. No.: US 2006/0023107 A1
(43) Pub. Date: Feb. 2, 2006

(54) Microelectronic imagers with optics supports having threadless interfaces and methods for manufacturing such microelectronic imagers

(76) Inventors: Todd O. Bolken, Star, ID (US); Chad A. Cobbley, Boise, ID (US)

Correspondence Address: PERKINS COIE LLP;PATENT-SEA, P.O. BOX 1247, SEATTLE, WA, 98111-1247, US

(21) Appl. No.: 10/910,491

(22) Filed: Aug. 2, 2004

(51) Int. Cl. H04N 5/225

(52) U.S. Cl. 348/335

(57) ABSTRACT

Microelectronic imagers comprising imaging units and optics units with optics supports having threadless interfaces and methods for packaging such microelectronic imagers are disclosed herein. In one embodiment, the imaging unit can include a microelectronic substrate and a microelectronic die on and/or in the substrate. A first referencing element having one or more inclined steps arranged about an axis is fixed to the imaging unit. The imager can further include an optics unit having an optic member. A second referencing element having one or more complementary inclined steps is fixed to the optics unit. The second referencing element is seated with the first referencing element and at least one of the referencing elements can be rotatably adjusted with respect to the other to position the optic member at a desired location relative to the image sensor.

### TECHNICAL FIELD

The present invention is related to microelectronic imagers and methods for packaging microelectronic imagers. Several aspects of the present invention are directed toward optics supports having threadless interfaces for microelectronic imagers and methods for manufacturing such microelectronic imagers.

### BACKGROUND

Microelectronic imagers are used in digital cameras, wireless devices with picture capabilities, and many other applications. Cell phones and Personal Digital Assistants (PDAs), for example, are incorporating microelectronic imagers for capturing and sending pictures. The growth rate of microelectronic imagers has been steadily increasing as they become smaller and produce better images with higher pixel counts.

Microelectronic imagers include image sensors that use Charged Coupled Device (CCD) systems, Complementary Metal-Oxide Semiconductor (CMOS) systems, or other solid state systems. CCD image sensors have been widely used in digital cameras and other applications. CMOS image sensors are also quickly becoming very popular because they are expected to have low production costs, high yields, and small sizes. CMOS image sensors can provide these advantages because they are manufactured using technology and equipment originally developed for fabricating semiconductor devices. CMOS image sensors, as well as CCD image sensors, are accordingly “packaged” to protect the delicate components and to provide external electrical contacts.

FIG. 1 is a schematic view of a conventional microelectronic imager 1 with a conventional package. The imager 1 includes a die 10, an interposer substrate 20 attached to the die 10, and a housing 30 attached to the interposer substrate 20. The housing 30 surrounds the periphery of the die 10 and has an opening 32. The imager 1 also includes a transparent cover 40 over the die 10.

The die 10 includes an image sensor 12 and a plurality of bond-pads 14 electrically coupled to the image sensor 12. The interposer substrate 20 is typically a dielectric fixture having a plurality of bond-pads 22, a plurality of ball-pads 24, and traces 26 electrically coupling the bond-pads 22 to corresponding ball-pads 24. The ball-pads 24 are arranged in an array for surface mounting the imager 1 to a board or module of another device. The bond-pads 14 on the die 10 are electrically coupled to the bond-pads 22 on the interposer substrate 20 by wire-bonds 28 to provide electrical pathways between the bond-pads 14 and the ball-pads 24. The interposer substrate 20 can also be a lead frame or ceramic housing.

The imager 1 shown in FIG. 1 also has an optics unit including a support 50 attached to the housing 30 and a barrel 60 adjustably attached to the support 50. The support 50 can include internal threads 52, and the barrel 60 can include external threads 62 engaged with the internal threads 52. The optics unit also includes a lens 70 carried by the barrel 60.

One problem with packaging conventional microelectronic imagers is that it is difficult to accurately align the lens with the image sensor. Referring to FIG. 1, the centerline of the lens 70 should be aligned with the centerline of the image sensor 12 within very tight tolerances. For example, in microelectronic imagers that have higher pixel counts and smaller sizes, the centerline of the lens 70 is often required to be within a few microns of the centerline of the image sensor 12. This is difficult to achieve with conventional imagers because the support 50 may not be positioned accurately on the housing 30. Moreover, because the barrel 60 is threaded onto the support 50, the necessary clearance between the threads can cause misalignment between the axes of the support 50 and the housing 60. Loss in concentricity because of non-coincident axes negatively affects the focus and/or clarity of the imager. Therefore, there is a need to align lenses with image sensors with greater precision in more sophisticated generations of microelectronic imagers.

Another problem of packaging conventional microelectronic imagers is that positioning the lens at a desired focus distance from the image sensor is time consuming and may be inaccurate. The lens 70 shown in FIG. 1 is spaced apart from the image sensor 12 at a desired distance by rotating the barrel 60 (arrow R) to adjust the elevation (arrow E) of the lens 70 relative to the image sensor 12. In practice, an operator manually rotates the barrel 60 by hand while watching an output of the imager 1 on a display until the picture is focused based on the operator's subjective evaluation. The operator then adheres the barrel 60 to the support 50 to secure the lens 70 in a position where it is spaced apart from the image sensor 12 by a suitable focus distance. This process is problematic because it is exceptionally time consuming and subject to operator errors.

Still another concern of conventional microelectronic imagers is that they are subject to failures caused by contaminants getting into the enclosed spaces of the housing 30 and the barrel 60. More specifically, the threads on the barrel 60 and the support 50 can be rough and have imperfections, such as burrs and/or voids at the apex of the threads. As such, small particles can come off of the threads and contaminate the image sensor 12 as the barrel 60 is threaded onto the support 50. A particle as small as 3-4 μm can cause the image sensor 12 to malfunction and/or become inoperable. Therefore, there is also a significant need to produce more robust packages that are not prone to contamination from particles off the threads.

### BRIEF DESCRIPTION OF THE DRAWINGS

FIG. 1 is a schematic cross-sectional view of a packaged microelectronic imager in accordance with the prior art.

FIG. 2A is a side cross-sectional view of an imaging unit for a microelectronic imager in accordance with an embodiment of the invention.

FIG. 2B is an isometric view of a first referencing element for use with the imaging unit of FIG. 2A.

FIG. 3A is a side cross-sectional view of an optics unit for a microelectronic imager in accordance with an embodiment of the invention.

FIG. 3B is an isometric view of a second referencing element for use with the optics unit of FIG. 3A.

FIG. 4A is a side cross-sectional view of a microelectronic imager with the imaging unit of FIG. 2A and the optics unit of FIG. 3A in accordance with an embodiment of the invention.

FIG. 4B is an isometric view of the first and second referencing elements of the imager of FIG. 4A before the referencing elements are seated with each other.

FIG. 4C is an isometric view including a cut-out portion of the first and second referencing elements of the imager of FIG. 4A after the referencing elements are seated with each other.

FIG. 4D is an isometric view including a cut-out portion of the first and second referencing elements of the imager of FIG. 4A after the referencing elements are seated together and rotatably adjusted with respect to each other.

FIG. 5A is a side cross-sectional view of a microelectronic imager in accordance with another embodiment of the invention.

FIG. 5B is an isometric view of the first and second referencing elements of the imager of FIG. 5A before the referencing elements are seated with each other.

FIG. 6A is a side cross-sectional view of a microelectronic imager in accordance with another embodiment of the invention.

FIG. 6B is an isometric view of the first and second referencing elements of the imager of FIG. 6A before the referencing elements are seated with each other.

### DETAILED DESCRIPTION

A. Overview

The following disclosure describes several embodiments of microelectronic imagers with optics supports and methods for assembling microelectronic imagers that use such optics supports. One aspect of the invention is directed toward a microelectronic imager comprising an imaging unit including a microelectronic substrate and a microelectronic die on and/or in the substrate. The die can include an image sensor and integrated circuitry operatively coupled to the image sensor. The microelectronic imager also includes a first referencing element fixed to the imaging unit, a second referencing element engaged with the first referencing element, and an optics unit attached to the second referencing element. The first referencing element includes an interface feature having one or more inclined steps arranged about an axis. The individual inclined steps include a ramp segment with an inclined surface curved about the axis and positioned at an inner diameter of the first referencing element. The second referencing element includes a second interface feature having one or more complementary inclined steps seated with the inclined steps of the first interface feature. The inclined steps of the second interface feature and the inclined steps of the first interface feature are complementary such that the optic member is at a desired location relative to the image sensor when the inclined steps are seated with each other.

The first and second referencing elements can have several different configurations. In one embodiment, for example, the first referencing element has a first interface feature with a plurality of inclined first ramp segments arranged about an axis, and the second referencing element has a second interface feature with a plurality of complementary inclined second ramp segments. In another embodiment, the first and second inclined steps each include only a single inclined ramp segment. In several embodiments, the first referencing element includes a first interface feature having a male configuration, and the second referencing element includes a second interface feature having a female configuration. The first and second interface features are configured to mate with or otherwise engage each other. In other embodiments, the male/female configuration of the first and second interface features can be reversed.

Another aspect of the invention is directed to methods of packaging microelectronic imagers. One embodiment of such a method includes providing an imaging unit including a microelectronic substrate, a microelectronic die having an image sensor and integrated circuitry operatively coupled to the image sensor, and a first referencing element fixed to the imaging unit. The first referencing element includes a first interface feature having one or more inclined steps arranged about an axis. The individual inclined steps include a ramp segment with an inclined surface curved about the axis and positioned at an inner diameter of the first referencing element. The method also includes providing an optics unit having an optic member and a second referencing element fixed to the optics unit. The second referencing element includes a second interface feature having one or more complementary inclined steps. The method further includes attaching the optics unit to the imaging unit by seating the first interface feature with the second interface feature to position the optic member at a desired location relative to the image sensor. In several embodiments, at least one of the first and second referencing elements can be rotatably adjusted relative to each other in a clockwise and/or counterclockwise direction to position the optic member at a desired focal distance with respect to the image sensor.

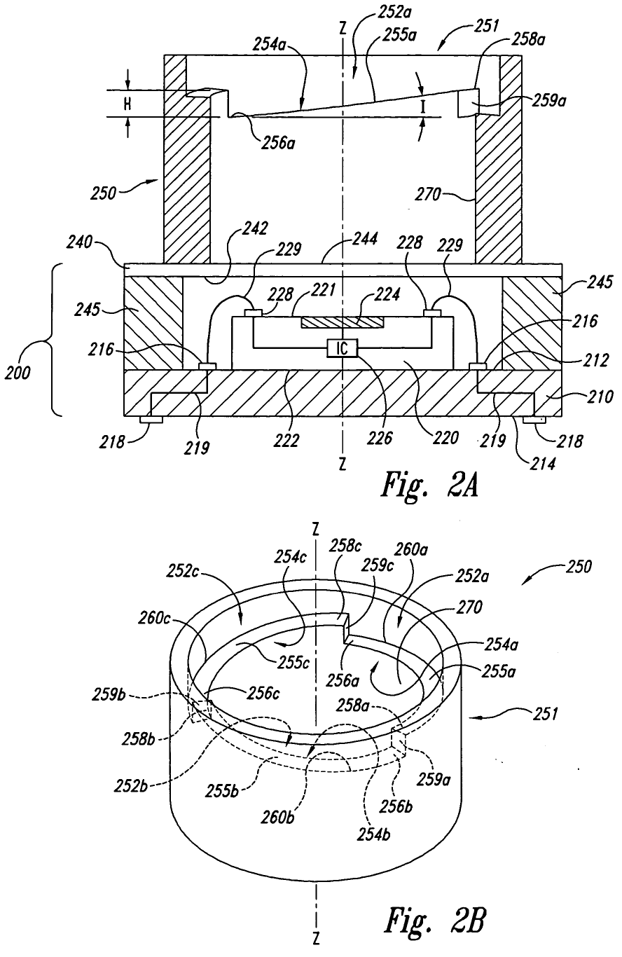

Specific details of several embodiments of the invention are described below with reference to CMOS imagers to provide a thorough understanding of these embodiments, but other embodiments can be CCD imagers or other types of sensors. Several details describing well-known structures often associated with microelectronic devices are not set forth in the following description to avoid unnecessarily obscuring the description of the disclosed embodiments. Additionally, several other embodiments of the invention can have different configurations or components than those described in this section. As such, a person of ordinary skill in the art will accordingly understand that the invention may have other embodiments with additional elements or without several of the elements shown and described below with reference to FIGS. 2A-6B.

B. Embodiments of Microelectronic Imagers with Optics Supports Having Threadless Interfaces

FIG. 2A is a side cross sectional view illustrating a microelectronic imaging unit 200 for use in a microelectronic imager in accordance with one embodiment of the invention. In this embodiment, the imaging unit 200 includes an interposer substrate 210 having a front side 212, a back side 214, and a microelectronic die 220 on and/or in the interposer substrate 210. The interposer substrate 210 further includes a plurality of contacts 216 at the front side 212 and a plurality of pads 218 at the back side 214. A plurality of traces 219 extend through the interposer substrate 210 and couple the individual contacts 216 to corresponding pads 218. The contacts 216 can be arranged in arrays for attachment to the die 220, and the pads 218 can be arranged in arrays for attachment to a plurality of electrical couplers (e.g., solder balls) for mounting the imager 200 to a board or module of another device.

The die 220 can include a front side 221, a back side 222, an image sensor 224, and integrated circuitry 226 operatively coupled to the image sensor 224. The die 220 can further include a plurality of terminals 228 (e.g., bond-pads) operatively coupled to the integrated circuitry 226. The image sensor 224 can be a CMOS device or a CCD image sensor for capturing pictures or other images in the visible spectrum, but the image sensor 224 can detect radiation in other spectrums (e.g., infrared (IR) or ultraviolet (UV) ranges). A plurality of wire-bonds 229 are formed to electrically couple each terminal 228 on the die 220 to corresponding contacts 216 on the interposer substrate 210. Although the terminals 228 are shown at the front side 221 of the die 220, they can also be at an intermediate depth within the die 220.

The imaging unit 200 can further include a cover 240 having a first side 242 facing generally toward the image sensor 224 and a second side 244 facing generally away from the image sensor 224. The cover 240 is mounted to spacers 245 projecting from the front side 212 of the interposer substrate 210. The cover 240 can be glass, quartz, or other materials transmissive to a desired spectrum of radiation. The cover 240 can further include one or more anti-reflective films and/or filters. In embodiments directed toward imaging radiation in the visible spectrum, the cover 240 can also filter infrared radiation or other undesirable spectrums of radiation. The cover 240, for example, can be formed from a material and/or can have a coating that filters IR or near IR spectrums.

The imaging unit 200 can further include a first referencing element 250 positioned relative to the image sensor 224. The first referencing element 250 is generally fixed in a position such that an axis of the first referencing element 250 is aligned with a desired axis of the image sensor 224.

FIG. 2B is an isometric view of the first referencing element 250. Referring to FIGS. 2A and 2B together, the first referencing element 250 is a first support projecting from the cover 240 of the imaging unit 200. In other embodiments, however, the first referencing element 250 may project from other portions of the imaging unit 200 instead of the cover 240 (e.g:, the interposer substrate 210). The first referencing element 250 can be made of a thermal plastic molding compound or a thermoset plastic. One advantage of thermoset plastic over thermal plastic is that thermoset plastic is dimensionally stable (i.e., very limited expansion/contraction). In other embodiments, the first referencing element 250 may be formed using another suitable material. As explained in more detail below, the first referencing element 250 is configured to receive a complementary referencing element of an optics unit in a threadless, rotatably adjustable position to accurately situate a lens or other optic member at a desired location with respect to the image sensor 224.

The embodiment of the first referencing element 250 shown in FIGS. 2A and 2B circumscribes the area above the image sensor 224. In this embodiment, the first referencing element 250 is circular. The first referencing element 250 can include a first interface feature 251 having one or more inclined steps 252 (identified individually by reference numbers 252a-c) at a common elevation around the inner diameter of the first referencing element 250. The inclined steps 252 have ramp segments 254 (identified individually by reference numbers 254a-c). In the illustrated embodiment, the ramp segments 254a-c are arranged concentrically about an adjustment axis (represented by the z-axis). The ramp segments 254a-c project inwardly normal to an inner wall of the first referencing element 250 and have inclined surfaces 255a-c with lower portions 256a-c and upper portions 258a-c. The ramp segments 254a-c also include risers 259a-c. The first interface feature 252 also includes axial alignment components 260a-c. As explained in more detail below, the inclined steps 252a-c provide adjustment of the focal distance for the optics unit and the alignment components 260a-c axially align the optics unit with the imager sensor 224.

The lower portions 256a-c of the inclined surfaces 255a-c are at a first common elevation with respect to the image sensor 224 and the upper portions 258a-c are at a second common elevation with respect to the image sensor 224. The difference between the first and second elevations (shown as H) defines an angle of inclination I. The inclined surfaces 255a-c are also curved around a portion of the inner diameter of the first referencing element 250. As described below, the complementary referencing element of the optics unit can be rotatably adjusted between the lower portions 256a-c and upper portions 258a-c of the inclined surfaces 255a-c to position a lens or optic member at a desired focus distance from the image sensor 224. The angle of inclination I can vary depending on the level of accuracy required for positioning the optic member. For example, a smaller angle of inclination provides better fine tuning for positioning the optic member at a desired location relative to the image sensor 224. On the other hand, a larger angle of inclination I provides greater vertical displacement for each degree of rotation to provide a larger range. The alignment components 260a-c are spaced laterally apart from the centerline of the image sensor 224 (represented by the z-axis) to provide a fixed surface at a known radial distance from the image sensor 224 for accurately aligning a lens or optic member with the image sensor 224.

The first referencing element 250 further includes an opening 270 through which radiation can pass to the image sensor 224. The opening 270 is generally sized so that the first referencing element 250 does not obstruct the image sensor 224, but this is not necessary. In several instances, the opening 270 of the first referencing element 250 is larger than the image sensor 224 to allow more light to reach the image sensor 224. The first referencing element 250, however, is generally not so large that it increases the overall footprint of the imaging unit 200.

The imaging unit 200 shown in FIG. 2A is one subassembly of one embodiment of a microelectronic imager in accordance with the invention. The other subassembly of the microelectronic imager is an optics unit configured to interface with the imaging unit 200 in a manner that reliably and accurately aligns an optic member with the image sensor 224 at a desired location. One aspect of several embodiments of the imaging unit 200, therefore, is to provide a referencing element 250 that interfaces with the optics unit and provides a desired level of adjustment to accurately position the optic member at a desired location relative to the image sensor 224.

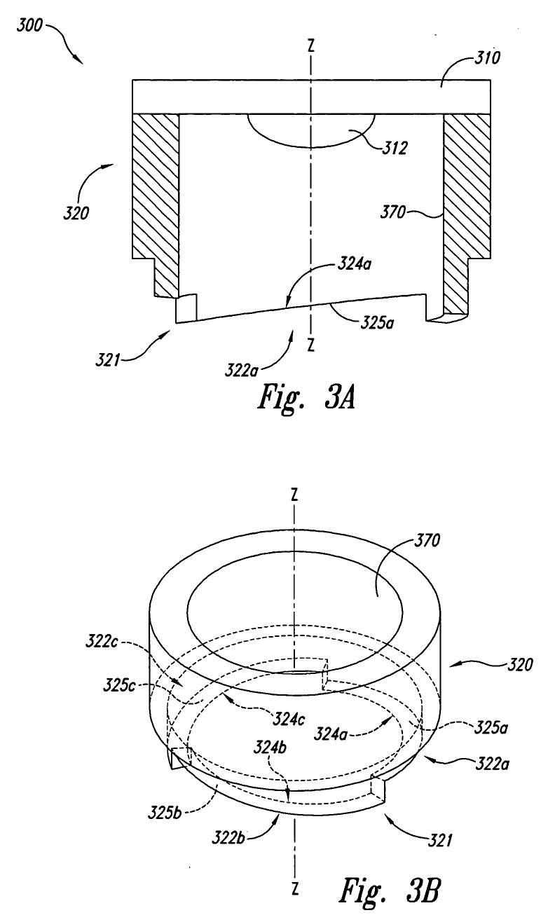

FIG. 3A is a side cross-sectional view of an optics unit 300 configured to be attached to the imaging unit 200 shown in FIG. 2A. In this embodiment, the optics unit 300 includes a substrate 310 and an optic member 312 on the substrate 310. The substrate 310 is typically a window that is transmissive to a selected radiation, and the optic member 312 can be a lens for focusing the light, a pinhole for reducing higher order refractions, and/or other optical structures for performing other functions.

The optics unit 300 further includes a second referencing element 320 attached to the substrate 310. FIG. 3B is an isometric view of the second referencing element 320. Referring to FIGS. 3A and 3B together, the second referencing element 320 is a second support projecting from the substrate 310 of the optics unit 300. The second referencing element 320 can be formed of materials similar to those of the first referencing element 250, as described above with reference to FIGS. 2A and 2B. The second referencing element 320 includes complementary features to the first referencing element 250. For example, the second referencing element 320 includes a second interface feature 321 having one or more inclined steps 322 (identified individually by reference numbers 322a-c) at a common elevation around the inner diameter of the second referencing element 320. The inclined steps 322 have ramp segments 324a-c arranged concentrically about an adjustment axis (represented by the z-axis). The ramp segments 324a-c project inwardly normal to an inner wall of the second referencing element 320 and have inclined surfaces 325a-c configured to contact the complementary inclined surfaces 255a-c of the first referencing element 250 (FIGS. 2A and 2B) to accurately situate the optic member 312 at a desired location with respect to the image sensor 224 (FIG. 2A). The second referencing element 320 can also include an opening 370.

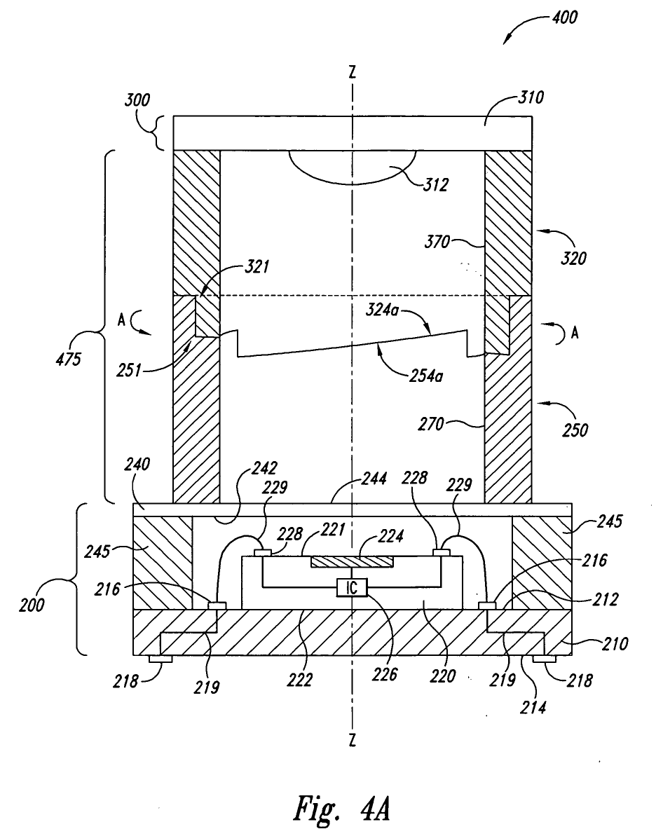

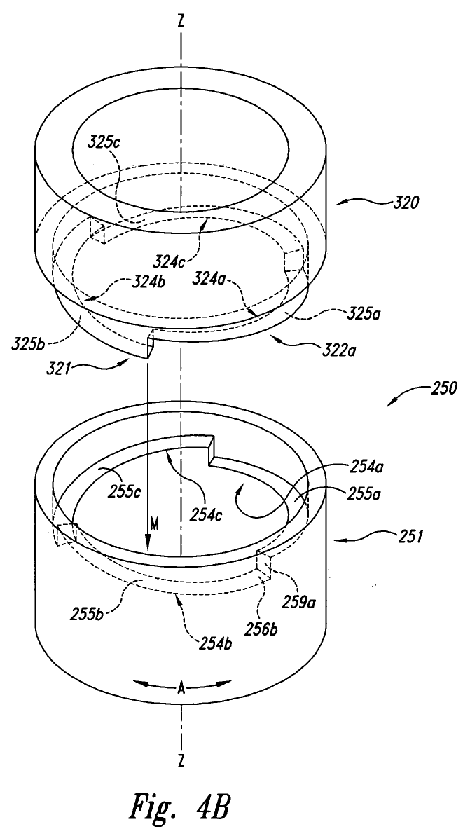

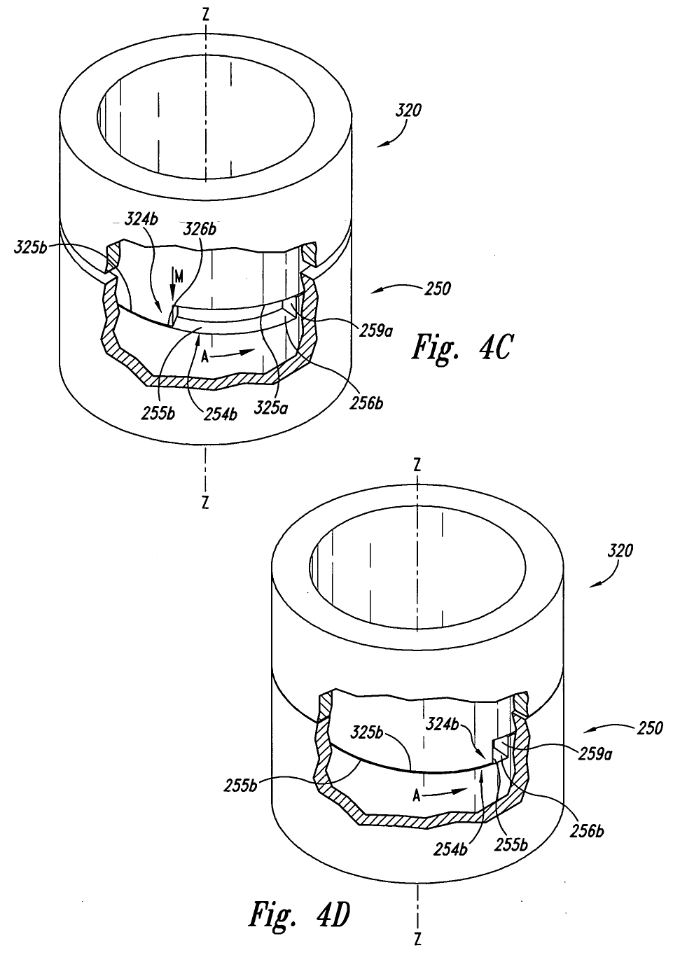

FIG. 4A is a side cross-sectional view of a microelectronic imager 400 including the imaging unit 200 of FIG. 2A and the optics unit 300 of FIG. 3A. In the illustrated embodiment, the first interface feature 251 (having a male configuration) of the first referencing element 250 is mated with the second interface feature 321 (having a female configuration) of the second referencing element 320. More specifically, the first interface feature 251 has an outer surface with a first cross-sectional dimension and the second interface feature 321 has an inner surface with a second cross-sectional dimension greater than the first cross-sectional dimension. The first interface feature 251 of the first referencing element 250 is received within the second interface feature 321 of the second referencing element 320. The mated first and second referencing elements 250 and 320 form an axially adjustable optics support 475. The optics unit 300 can be rotated (as shown by the arrow A) such that the second ramp segments 324a-c slide along the first ramp segments 254a-c to raise/lower the optics unit 300 in a manner that accurately situates the optic member 312 at a desired location with respect to the image sensor 224.

FIG. 4B is an isometric view of the first and second referencing elements 250 and 320 of the imager 400 before the referencing elements are seated together. FIG. 4C is an isometric view including a cut-out portion of the first and second referencing elements 250 and 320 after they have been seated together. Referring to FIGS. 4B and 4C together, the first ramp segments 254a-c of the first referencing element 250 are seated with the complementary second ramp segments 324a-c of the second referencing element 320. For example, in the illustrated embodiment an upper portion 326b of the ramp segment 324b on the second referencing element 320 is initially positioned (as shown by the arrow M) proximate a midpoint of the corresponding ramp segment 254b of the first referencing element 250. In other embodiments, the second ramp segments 324a-c of the second referencing element 320 can be seated at different locations along the corresponding first ramp segments 254a-c of the first referencing element 250.

After seating the first and second referencing elements 250 and 320 together, at least one of the referencing elements can be rotatably adjusted relative to the other in a clockwise and/or counterclockwise direction to position the optic member 312 (FIG. 4A) at a desired focal distance along the z-axis from the image sensor 224 (FIG. 4A). FIG. 4D is an isometric view including a cut-out portion of the first and second referencing elements 250 and 320 after the referencing elements have been seated together and rotatably adjusted. In the illustrated embodiment, for example, the second referencing element 320 was rotated along the first referencing element 250 in a counterclockwise direction (as shown by the arrow A) to a different rotational position. More specifically, the second ramp segment 324b was rotatably moved along the first ramp segment 254a in the direction A, thus causing the optic member 312 (FIG. 4A) to move from a first elevation to a second lower elevation along the z-axis based on the slope of the inclined surface 255b and the distance the second ramp segment 324b was rotated along the first ramp segment 254b.

When the optic member 312 (FIG. 4A) is at the desired location, the second referencing element 320 can be secured to the first referencing element 250 along the first and second interface features 251 and 321 (FIG. 4A) using an adhesive, a heat stake (e.g., a type of thermoset adhesive), and/or an interference fit. For example, the referencing elements 250 and 320 are secured together using the interference fit method by heating one of the referencing elements (e.g., the first referencing element 250) before seating the referencing elements together. After seating the heated first referencing element 250 with the cooler second referencing element 320, the first and second referencing elements 250 and 320 are brought to an equilibrium temperature. At the equilibrium temperature, the referencing elements become fixed together.

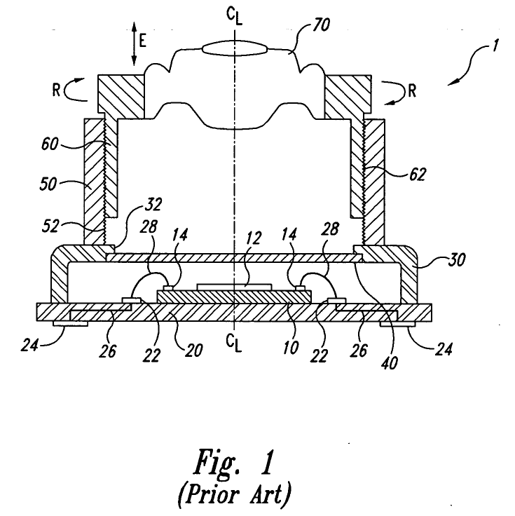

The imager 400 shown in FIG. 4A has several advantages compared to the conventional imager shown in FIG. 1 with a threaded barrel for positioning the optics unit. One advantage is that the optics support 475 has a threadless interface. This feature helps prevent contamination from the threads of the conventional imager of FIG. 1, which have small burrs that can come off and contaminate the image sensor as the barrel 60 (FIG. 1) is threaded onto the support 50 (FIG. 1). In contrast, the first and second referencing elements 250 and 320 of the imager 400 are rotatably adjustable along the threadless interface defined by the smooth inclined surfaces 254a-c and 324a-c. Accordingly, the likelihood of particles falling onto the image sensor 224 is significantly reduced.

Another feature of the microelectronic imager 400 illustrated in FIG. 4A is that the threadless interface of the optics support 475 between the first and second referencing elements 250 and 320 provides better alignment of the optics unit 300 and imaging unit 200. For example, there is no clearance between the ramp segments 254a-c and 324a-c when the first and second referencing elements 250 and 320 are seated together. Accordingly, the z-axis of the optics unit 300 is coincident with the z-axis of the imaging unit 200. In contrast, the components of the conventional imager of FIG. 1 are fixed together using a threaded interface that inherently requires a certain degree of clearance between the threads and can result in misalignment of the imager components (i.e., non-coincident axes).

The embodiment of the imager 400 shown in FIG. 4A is further expected to significantly improve the efficiency of packaging imagers compared to the conventional imager of FIG. 1. The optics unit 300 can be attached to the imaging unit 200 using automated equipment because the interface between the first and second referencing elements 250 and 320 inherently positions the optic member 312 at a location relative to the image sensor 224. For example, the alignment components 260a-c of the first referencing element 250 and the complementary alignment components of the second referencing element 320 accurately position the optic member 312 at a desired lateral distance from the image sensor 224. In addition, the optics unit 300 can be rotatably adjusted relative to the imaging unit 200 using automated equipment while automatically testing the focus of the optic member 312 with respect to the image sensor 224. The imager 400 accordingly eliminates manually positioning and focusing individual lenses with respect to image sensors, as described above with respect to the conventional imager of FIG. 1. Therefore, the structure of the imager 400 enables processes that significantly enhance the throughput and yield of packaging microelectronic imagers.

C. Additional Embodiments of Microelectronic Imagers with Optics Supports Having Threadless Interfaces

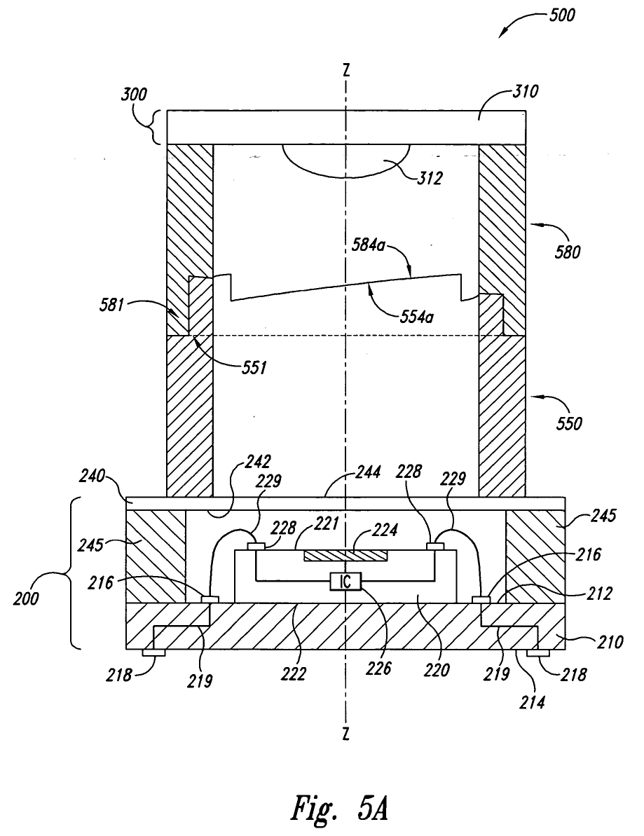

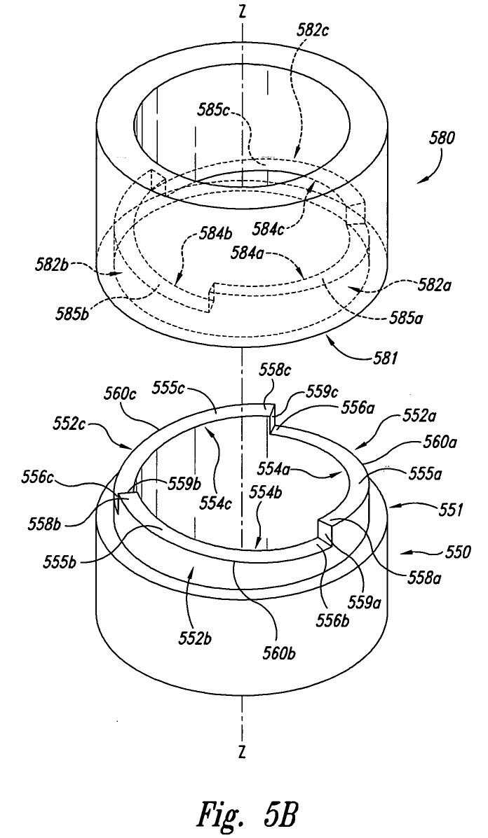

FIG. 5A is a side cross-sectional view of a microelectronic imager 500 and FIG. 5B is an isometric view of a first and a second referencing element 550 and 580 before the referencing elements are mated together in accordance with another embodiment of the invention. The microelectronic imager 500 can include generally the same components as the microelectronic imager 400 described above with respect to FIG. 4A; like reference numbers accordingly refer to like components in FIGS. 4A and 5A. Referring to FIGS. 5A and 5B, the imager 500 has the imaging unit 200 and the optics unit 300 described above. The imaging unit 200 further includes a first referencing element 550.

The first referencing element 550 can include a first interface feature 551 having one or more inclined steps 552 (identified individually by reference numbers 552a-c) at a common elevation around the inner diameter of the first referencing element 550. The inclined steps 552 have ramp segments 554a-c arranged concentrically about the z-axis. The ramp segments 554a-c have inclined surfaces 555a-c with lower portions 556a-c and upper portions 558a-c. The ramp segments 554a-c also include risers 559a-c. The first interface feature 551 also includes axial alignment components 560a-c to axially align the optics unit 300 with the image sensor 224.

The imager 500 further includes a second referencing element 580 fixed to the optics unit 300. The second referencing element 580 includes a second interface feature 581 having one or more inclined steps 582 (identified individually by reference number 582a-c) at a common elevation around the inner diameter of the second referencing element 580. The inclined steps 582a-c have ramp segments 584a-c arranged concentrically about the z-axis. The ramp segments 584a-c have inclined surfaces 585a-c configured to contact the complementary inclined surfaces 555a-c of the first referencing element 550 to accurately situate the optic member 312 at a desired location with respect to the image sensor 224. The primary difference between the imager 500 shown in FIG. 5A and the imager 400 shown in FIG. 4A is that the first interface feature 551 of the first referencing element 550 has a male configuration and the second interface feature 581 of the second referencing element 580 has a female configuration. The first and second referencing elements 250 and 320 of the imager 400 shown in FIG. 4 have an inverse male/female configuration (i.e., the first interface feature 251 has a female configuration and the second interface feature 321 has a male configuration). One advantage of the male/female configuration of the first and second interface features 551 and 581 of the imager 500 is that it further reduces the potential for particles to fall onto the image sensor 224 because the contact area between the first and second interface features 551 and 581 is outside of the area above the image sensor 224.

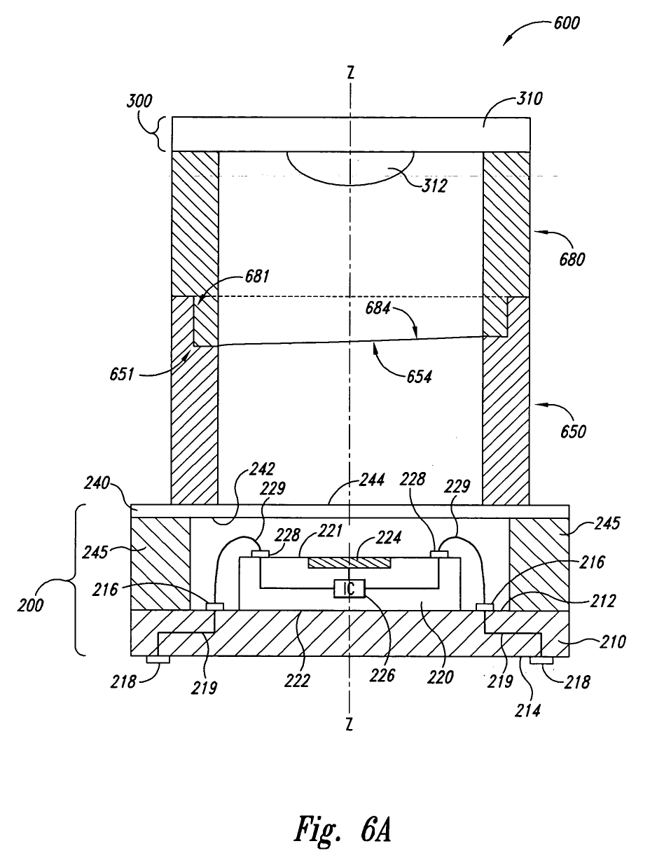

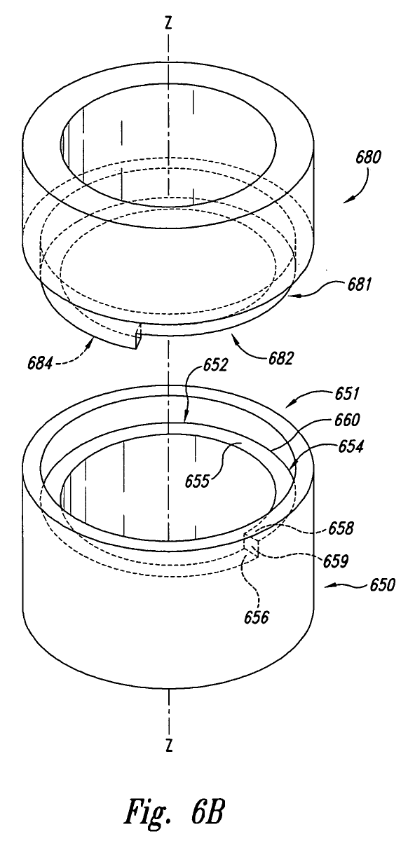

FIG. 6A is a side cross-sectional view of a microelectronic imager 600 and FIG. 6B is an isometric view of a first and a second referencing element 650 and 680 before the referencing elements are mated together in accordance with another embodiment of the invention. The microelectronic imager 600 can include generally the same components as the microelectronic imager 400 described above with respect to FIG. 4A; like reference numbers accordingly refer to like components in FIGS. 4A and 6A. Referring to FIGS. 6A and 6B, the imager 600 can include the imaging unit 200 having the first referencing element 650 fixed to the cover 240. The primary difference between the imager 600 shown in FIG. 6A and the imager 400 shown in FIG. 4A is that the first referencing element 650 includes a first interface feature 651 having only one inclined step 652 that extends concentrically 360° about the z-axis. The inclined step 652 has a ramp segment 654 having an inclined surface 655 with a lower portion 656 and an upper portion 658. The ramp segment 654 further includes a riser 659 and an axial alignment component 660.

The imager 600 further includes the optics unit 300 with the second referencing element 680 and a second interface feature 681. The second interface feature 681 includes a complementary single inclined step 682 having a ramp segment 684 configured to mate with the ramp segment 654 of the first referencing element 650. In this embodiment, the first interface feature 651 has a male configuration and the second interface feature 681 has a female configuration. In other embodiments, the male/female configuration of the first and second interface features 651 and 681 may be reversed. The imager 600 is expected to have many of the same advantages of the imagers 400 and 500 described above.

From the foregoing, it will be appreciated that specific embodiments of the invention have been described herein for purposes of illustration, but that various modifications may be made without deviating from the spirit and scope of the invention. For example, various aspects of any of the foregoing embodiments can be combined in different combinations. Accordingly, the invention is not limited except as by the appended claims.

I claim:

1. A microelectronic imager, comprising:
an imaging unit including a microelectronic substrate and a microelectronic die on and/or in the substrate, the die having an image sensor and integrated circuitry operatively coupled to the image sensor;
a first referencing element fixed to the imaging unit, the first referencing element including a first interface feature having one or more inclined steps arranged about an axis, the individual steps having a ramp segment with an inclined surface curved about the axis and positioned at an inner and/or outer diameter of the first referencing element;
an optics unit having an optic member; and
a second referencing element fixed to the optics unit, the second referencing element including a second interface feature having one or more complementary inclined steps seated with the one or more inclined steps of the first interface feature to position the optic member at a desired location relative to the image sensor.

2. The imager of claim 1 wherein:
the first interface feature comprises a first inclined step; and
the second interface feature comprises a second complementary inclined step mated with the first inclined step, and wherein after mating the first and second referencing elements are rotatably adjustable with respect to each other to position the optic member at a desired location on the axis relative to the image sensor.

3. The imager of claim 1 wherein:
the first interface feature comprises a plurality of inclined steps; and
the second interface feature comprises a plurality of complementary inclined steps mated with corresponding inclined steps of the first interface feature, and wherein the first and second referencing elements are rotatably adjustable with respect to each other to position the optic member at a desired location on the axis relative to the image sensor.

4. The imager of claim 1 wherein:
the first interface feature further comprises a first axial alignment component; and
the second interface feature further comprises a second axial alignment component, and wherein the first axial alignment component is seated with the second axial alignment component to axially align the optic member with the image sensor.

5. The imager of claim 1 wherein the individual inclined steps of the first and second interface features further comprise a riser portion along the individual ramp segments, and wherein the riser portions are configured to limit rotation of the first and second referencing elements with respect to each other after the first and second referencing elements have been seated together.

6. The imager of claim 1 wherein:
the first referencing element comprises a first support projecting from one of the substrate or a cover over the die; and
the second referencing element comprises a second support projecting from the optics unit, and wherein the first support is mated with the second support.

7. The imager of claim 1 wherein:
the imaging unit further comprises a cover over the image sensor, the cover being transmissive to a desired spectrum of radiation for the image sensor;
the first referencing element comprises a first support projecting from the cover; and
the second referencing element comprises a second support projecting from the optics unit and wherein the second support is seated with the first support and rotatably adjustable with respect to the first support to position the optic member at a desired location on the axis relative to the image sensor.

8. The imager of claim 1 wherein:
the imaging unit further comprises a cover over the image sensor, the cover being transmissive to a desired spectrum of radiation for the image sensor;
the first referencing element comprises a first support projecting from the cover, the first support including a plurality of inclined steps arranged concentrically about the axis at a common elevation along the first referencing element; and
the second referencing element comprises a second support projecting from the optics unit, wherein the second support includes a plurality of complementary inclined steps at a common elevation along the second referencing element, the inclined steps of the second referencing element being mated with corresponding inclined steps of the first support, and wherein the second support is rotatably adjustable with respect to the first support to position the optic member at a desired location on the axis relative to the image sensor.

9. The imager of claim 1 wherein:
the first interface feature has a male configuration; and
the second interface feature has a female configuration, and wherein the first interface feature is mated with the second interface feature.

10. The imager of claim 1 wherein:
the first interface feature has a female configuration; and
the second interface feature has a male configuration, and wherein the first interface feature is mated with the second interface feature.

11. The imager of claim 1 wherein:
the first referencing element projects from one of the substrate or a cover over the die and extends around the image sensor; and
the second referencing element projects from the optics unit and extends around the optic member.

12. The imager of claim 1 wherein:
the substrate includes a front side and a back side;
the die includes a front side and a back side, and wherein the back side of the die engages the front side of the substrate; and
the imaging unit further comprises external contacts electrically coupled to the integrated circuit, the external contacts including first terminals at the front side of the die, second terminals at the front side of the substrate operatively coupled to the first terminals on the die, a plurality of contact pads at the back side of the substrate, and conductive links extending through the substrate coupling the second terminals to the contact pads at the back side of the substrate.

13. The imager of claim 1 wherein the first and second referencing elements are mated together to form an optics support.

14. The imager of claim 1 wherein the first and second referencing elements comprise a thermal plastic molding compound and/or a thermoset plastic material.

15. The imager of claim 1 wherein the first and second referencing elements are fixed together using an adhesive, a heat stake, and/or an interference fit.

16. The imager of claim 1 wherein:
the first referencing element is at a first temperature; and
the second referencing element is at a second temperature greater than the first temperature when the first and second referencing elements are placed in contact with each other, and wherein the first referencing element is fixed to the second referencing element upon the first and second temperatures reaching an equilibrium.

17. A microelectronic imager, comprising:
an imaging unit including a microelectronic substrate and a microelectronic die on and/or in the substrate;
a first referencing element fixed to the imaging unit, the first referencing element including a first interface feature having an inclined first ramp segment arranged about a z-axis, the first ramp segment including an inclined surface curved about the z-axis and a riser;
an optics unit having an optic member; and
a second referencing element fixed to the optics unit, the second referencing element including a second interface feature having an inclined second ramp segment including an inclined surface curved about the z-axis and a riser, the second ramp segment being mated with the first ramp segment of the first interface feature to position the optic member at a desired location relative to the die.

18. The imager of claim 17 wherein:
the die comprises an image sensor and integrated circuitry operatively coupled to the image sensor; and
the imaging unit further comprises a cover over the die.

19. The imager of claim 17 wherein the first ramp segment and the second ramp segment are rotatably adjustable with respect to each other to position the optic member at a desired location on the z-axis relative to the die.

20. The imager of claim 17 wherein:
the first interface feature comprises a plurality of inclined first ramp segments; and
the second interface feature comprises a plurality of complementary inclined second ramp segments mated with corresponding first ramp segments of the first interface feature, and wherein the first and second referencing elements are rotatably adjustable with respect to each other to position the optic member at a desired location on the z-axis relative to the die.

21. The imager of claim 17 wherein:
the first referencing element comprises a first support projecting from one of the substrate or a cover over the die; and
the second referencing element comprises a second support projecting from the optics unit, and wherein the first support is mated with the second support.

22. The imager of claim 17 wherein:
the first referencing element comprises a first support projecting from a cover over the die, the cover being transmissive to a desired spectrum of radiation; and
the second referencing element comprises a second support projecting from the optics unit, and wherein the second support is seated with the first support and rotatably adjustable with respect to the first support to position the optic member at a desired location on the z-axis relative to the die.

23. The imager of claim 17 wherein:
the first referencing element comprises a first support projecting from a cover over the die, the cover being transmissive to a desired spectrum of radiation, and wherein the first support includes three inclined first ramp segments arranged about the z-axis at a common elevation of the first referencing element; and
the second referencing element comprises a second support projecting from the optics unit, wherein the second support includes three complementary inclined second ramp segments at a common elevation of the second referencing element, the second ramp segments being mated with the first ramp segments, and wherein the second support is rotatably adjustable with respect to the first support to position the optic member at a desired location on the z-axis from the die.

24. The imager of claim 17 wherein:
the first interface feature has a male configuration; and
the second interface feature has a female configuration, and wherein the first interface feature is received within the second interface feature.

25. The imager of claim 17 wherein:
the first interface feature has a female configuration; and
the second interface feature has a male configuration, and wherein the first interface feature receives the second interface feature.

26. The imager of claim 17 wherein:
the first referencing element projects from one of the substrate or a cover over the die and extends around an image sensor on the die; and
the second referencing element projects from the optics unit and extends around the optic member.

27. The imager of claim 17 wherein:
the substrate includes a front side and a back side;
the die includes a front side and a back side, and wherein the back side of the die engages the front side of the substrate; and
the imaging unit further comprises external contacts electrically coupled to an integrated circuit, the external contacts including first terminals at the front side of the die, second terminals at the front side of the substrate operatively coupled to the first terminals on the die, a plurality of contact pads at the back side of the substrate, and conductive links extending through the substrate coupling the second terminals to the contact pads at the back side of the substrate.

28. The imager of claim 17 wherein the first and second referencing elements are mated together to form an optics support.

29. The imager of claim 17 wherein the first and second referencing elements comprise a thermal plastic molding compound and/or a thermoset plastic material.

30. The imager of claim 17 wherein the first and second referencing elements are fixed together using an adhesive, a heat stake, and/or an interference fit.

31. The imager of claim 17 wherein:
the first referencing element is at a first temperature; and
the second referencing element is at a second temperature greater than the first temperature when the first and second referencing elements are placed in contact with each other, and wherein the first referencing element is fixed to the second referencing element upon the first and second temperatures reaching an equilibrium.

32. A microelectronic imager, comprising:
an imaging unit including (a) a microelectronic substrate and (b) a microelectronic die on and/or in the substrate, the die having an image sensor and integrated circuitry operatively coupled to the image sensor;
a first referencing element fixed to the imaging unit, the first referencing element including a wall projecting from the imaging unit and a first interface feature having a plurality of inclined steps arranged about an adjustment axis, the individual steps having ramp segments normal to the wall and inclined relative to the adjustment axis, and wherein the first interface feature has an outer surface with a first cross-sectional dimension;
an optics unit having an optic member; and
a second referencing element fixed to the optics unit, the second referencing element including a second interface feature having a plurality of complementary inclined steps and an inner surface with a second cross-sectional dimension greater than the first cross-sectional dimension, and wherein the first interface feature is mated with the second interface feature to position the optic member at a desired location relative to the image sensor.

33. The imager of claim 32 wherein after mating the first and second referencing elements are rotatably adjustable with respect to each other in a clockwise and/or counterclockwise direction to position the optic member at a desired location on the adjustment axis relative to the image sensor.

34. The imager of claim 32 wherein:
the first referencing element comprises a first support projecting from the substrate; and
the second referencing element comprises a second support projecting from the optics unit, and wherein the second support is mated with the first support and rotatably adjustable with respect to the first support to position the optic member at a desired location on the adjustment axis relative to the image sensor.

35. The imager of claim 32 wherein:
the first referencing element comprises a first support projecting from a cover over the die; and
the second referencing element comprises a second support projecting from the optics unit, and wherein the second support is mated with the first support and rotatably adjustable with respect to the first support to position the optic member at a desired location on the adjustment axis relative to the image sensor.

36. The imager of claim 32 wherein the first and second referencing elements comprise a thermal plastic molding compound and/or a thermoset plastic material.

37. The imager of claim 32 wherein the first and second referencing elements are fixed together using an adhesive, a heat stake, and/or an interference fit.

38. A microelectronic imager, comprising:
an imaging unit including (a) a microelectronic substrate and (b) a microelectronic die on and/or in the substrate, the die having an image sensor and integrated circuitry operatively coupled to the image sensor;
a first referencing element fixed to the imaging unit, the first referencing element including a first interface feature having a plurality of inclined first ramp segments arranged about an adjustment axis, the individual first ramp segments including an inclined surface curved about the adjustment axis and a riser, and wherein the first interface feature has a inner surface with a first cross-sectional dimension;
an optics unit having an optic member; and
a second referencing element fixed to the optics unit, the second referencing element including a second interface feature having a plurality of complementary inclined second ramp segments, the individual second ramp segments including an inclined surface curved about the adjustment axis and a riser, and wherein the second interface feature has an outer surface with a second cross-sectional dimension less than the first cross-sectional dimension, the second ramp segments being mated with the first ramp segments of the first interface feature to position the optic member at a desired location relative to the image sensor.

39. The imager of claim 38 wherein after mating the first and second referencing elements are rotatably adjustable with respect to each other in a clockwise and/or counterclockwise direction to position the optic member at a desired location on the adjustment axis relative to the image sensor.

40. The imager of claim 38 wherein:
the first referencing element comprises a first support projecting from the substrate; and
the second referencing element comprises a second support projecting from the optics unit, and wherein the second support is mated with the first support and rotatably adjustable with respect to the first support to position the optic member at a desired location on the adjustment axis relative to the image sensor.

41. The imager of claim 38 wherein:
the first referencing element comprises a first support projecting from a cover over the die; and
the second referencing element comprises a second support projecting from the optics unit, and wherein the second support is mated with the first support and rotatably adjustable with respect to the first support to position the optic member at a desired location on the adjustment axis relative to the image sensor.

42. The imager of claim 38 wherein the first and second referencing elements comprise a thermal plastic molding compound and/or a thermoset plastic material.

43. The imager of claim 38 wherein the first and second referencing elements are fixed together using an adhesive, a heat stake, and/or an interference fit.

44. A microelectronic imager, comprising:
an imaging unit including a microelectronic substrate and a microelectronic die on and/or in the substrate, the die having an image sensor and integrated circuitry operatively coupled to the image sensor;
a first member having an inner wall projecting along an adjustment axis away from the imaging unit, the first member including a first ramp segment projecting inwardly normal to the inner wall and inclined relative to the adjustment axis;
an optics unit having an optic member; and
a second member having an inner wall projecting along the adjustment axis away from the optics unit, the second member including a second ramp segment projecting inwardly normal to the inner wall and inclined relative to the adjustment axis, the second member being mated with the first member to position the optic member at a desired location relative to the image sensor.

45. The imager of claim 44 wherein the first and second ramp segments of the first and second members further comprise a riser portion along the individual ramp segments, and wherein the riser portions are configured to limit rotation of the first and second members with respect to each other after the first and second members have been mated.

46. A microelectronic imager, comprising:
an imaging unit including a microelectronic substrate and a microelectronic die on and/or in the substrate, the die having an image sensor and integrated circuitry operatively coupled to the image sensor;
an optics support fixed to the imaging unit, the optics support having a first referencing element and a second referencing element rotatably adjustable with respect to each other along a threadless interface to move axially along an adjustment axis; and
an optics unit having an optic member fixed to the optics support, wherein at least one of the first and second referencing elements are moved clockwise and/or counterclockwise with respect to each other to position the optic member at a desired location on the adjustment axis relative to the image sensor.

47. A microelectronic imager, comprising:
an imaging unit including a microelectronic substrate and a microelectronic die on and/or in the substrate, the die having an image sensor and integrated circuitry operatively coupled to the image sensor;
a first member having an inner wall projecting along an adjustment axis away from the imaging unit, the first member including a first ramp segment inclined relative to the adjustment axis;
an optics unit having an optic member; and
a second member having an inner wall projecting along the adjustment axis away from the optics unit, the second member including a second ramp segment inclined relative to the adjustment axis, the second member being mated with the first member to move axially along the adjustment axis to position the optic member at a desired location relative to the image sensor, and wherein the maximum adjustment of the first and second members along the adjustment axis is limited to 360 degrees rotation.

48. A microelectronic imager, comprising:
an imaging unit including (a) a microelectronic substrate, (b) a microelectronic die on and/or in the substrate, the die having an image sensor, integrated circuitry operatively coupled to the image sensor, and external contacts electrically coupled to the integrated circuitry, and (c) a cover over the die, the cover being transmissive to a desired spectrum of radiation for the image sensor;
optics support means fixed to the cover, the optics support means including (a) a first referencing element having one or more inclined ramp segments arranged about an axis, the individual ramp segments including a horizontal portion curved about the axis and positioned at an inner diameter of the first referencing element, and (b) a second referencing element having one or more complementary inclined ramp segments mated with the one or more inclined ramp segments of the first referencing element; and
an optics unit having an optic member fixed to the optics support means, and wherein the optics support means includes adjustment means for rotatably adjusting the first and second referencing elements along the interface between corresponding ramp segments to position the optic member at a desired location along the axis relative to the image sensor.

49. A method of packaging a microelectronic imager, comprising:
providing an imaging unit including (a) a microelectronic substrate, (b) a microelectronic die having an image sensor and integrated circuitry operatively coupled to the image sensor, and (c) a first referencing element fixed to the imaging unit, the first referencing element including a first interface feature having one or more inclined steps arranged about an axis, the individual steps having a ramp segment with an inclined surface curved about the axis and positioned at an inner and/or outer diameter of the first referencing element;
providing an optics unit having an optic member and a second referencing element fixed to the optics unit, the second referencing element including a second interface feature having one or more complementary inclined steps; and
attaching the optics unit to the imaging unit by seating the first interface feature with the second interface feature to position the optic member at a desired location relative to the image sensor.

50. The method of claim 49, further comprising rotatably adjusting at least one of the first and second referencing elements relative to each other after seating the first and second interface features together to position the optic member at a desired location relative to the image sensor.

51. The method of claim 49, further comprising rotatably adjusting at least one of the first and second referencing elements relative to each other in a clockwise and/or counterclockwise direction after seating the first and second interface features together to position the optic member at a desired location relative to the image sensor.

52. The method of claim 49 wherein the first referencing element comprises a first support projecting from one of the substrate or a cover over the die and the second referencing element comprises a second support projecting from the optics unit, and wherein attaching the optics unit to the imaging unit comprises engaging the first support with the second support.

53. The method of claim 49 wherein the first referencing element comprises a first support projecting from one of the substrate or a cover over the die and the second referencing element comprises a second support projecting from the optics unit, the first support having three inclined ramp segments arranged about an axis and the second support having three complementary inclined ramp segments, and wherein attaching the optics unit to the imaging unit comprises mating the first support with the second support.

54. The method of claim 49 wherein the first referencing element comprises a first support having a male configuration projecting from one of the substrate or a cover over the die and the second referencing element comprises a second support having a female configuration projecting from the optics unit, and wherein attaching the optics unit to the imaging unit comprises mating the first support with the second support.

55. The method of claim 49 wherein the first referencing element comprises a first support having a female configuration projecting from one of the substrate or a cover over the die and the second referencing element comprises a second support having a male configuration projecting from the optics unit, and wherein attaching the optics unit to the imaging unit comprises mating the first support with the second support.

56. The method of claim 49 wherein mating the first and second referencing elements comprises fixing the first and second referencing elements together using an adhesive, a heat stake, and/or an interference fit.

57. The method of claim 49 wherein attaching the optics unit to the imaging unit and rotatably adjusting the first and/or second referencing elements relative to each other comprises moving at least one of the imaging unit and the optics unit using automated equipment.

58. A method of packaging a microelectronic imager including an imaging unit having a microelectronic substrate and a microelectronic die on and/or in the substrate, the die having an image sensor and integrated circuitry operatively coupled to the image sensor, the method comprising:
attaching an optics unit having an optic member to the imaging unit by mating a first referencing element fixed to the imaging unit and having a plurality of inclined first ramp segments arranged about an axis with a second referencing element fixed to the optics unit and having a plurality of complementary inclined second ramp segments arranged about the axis, the individual first and second ramp segments including inclined surfaces curved about the axis and risers; and
rotatably adjusting at least one of the first and second referencing elements relative to each other in a clockwise and/or counterclockwise direction to position the optic member at a desired location along the axis relative to the image sensor.

59. The method of claim 58 wherein the first referencing element comprises a first support projecting from one of the substrate or a cover over the die and the second referencing element comprises a second support projecting from the optics unit, the first support having three inclined first ramp segments arranged about the axis and the second support having three complementary inclined second ramp segments, and wherein attaching the optics unit to the imaging unit comprises mating the first support with the second support.

60. The method of claim 58 wherein the first referencing element comprises a first support having a male configuration projecting from one of the substrate or a cover over the die and the second referencing element comprises a second support having a female configuration projecting from the optics unit, and wherein attaching the optics unit to the imaging unit comprises mating the first support with the second support.

61. The method of claim 58 wherein the first referencing element comprises a first support having a female configuration projecting from one of the substrate or a cover over the die and the second referencing element comprises a second support having a male configuration projecting from the optics unit, and wherein attaching the optics unit to the imaging unit comprises mating the first support with the second support.

62. The method of claim 58 wherein mating the first and second referencing elements comprises fixing the first and second referencing elements together using an adhesive, a heat stake, and/or an interference fit.

63. The method of claim 58 wherein attaching the optics unit to the imaging unit and rotatably adjusting the first and/or second referencing elements relative to each other comprises moving at least one of the imaging unit and the optics unit using automated equipment.

64. A method of packaging a microelectronic imager including an imaging unit having a microelectronic substrate and a microelectronic die on and/or in the substrate, the die having an image sensor and integrated circuitry operatively coupled to the image sensor, the method comprising:
sliding a first member having an inner wall projecting away from the imaging unit axially along an adjustment axis into a second member until a first interface feature of the first member contacts a second interface feature of the second member, the first interface feature having a first ramp segment projecting inwardly normal to the inner wall and inclined relative to the adjustment axis and the second interface feature having a complementary second ramp segment projecting inwardly normal to the inner wall of the first member and inclined relative to adjustment axis; and
rotatably adjusting at least one of the first and second members less than 360 degrees to position the optic member at a desired location along the adjustment axis relative to the image sensor.

65. The method of claim 64 wherein sliding the first member along the adjustment axis into the second member comprises sliding the first member along the adjustment axis without rotating the first member before the first interface feature contacts the second interface feature.

66. A method of packaging a microelectronic imager including an imaging unit having a microelectronic substrate and a microelectronic die on and/or in the substrate, the die having an image sensor and integrated circuitry operatively coupled to the image sensor, the method comprising:
engaging a plurality of first step segments at a common first elevation along a first referencing element fixed to the imaging unit with a corresponding plurality of second step segments at a common second elevation along a second referencing element fixed to the optics unit; and
rotating the first and second referencing elements with respect to each other to move the optic member to a desired location along a z-axis relative to the image sensor.
